(19) United States
(12) Patent Application Publication
(10) Pub. No.: US 2004/0259711 A1
(43) Pub. Date: Dec. 23, 2004

(54) Wet classification device

(76) Inventor: Guntram Krettek, Viersen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/491,474

(22) PCT Filed: Oct. 6, 2001
(86) PCT No.: PCT/DE01/03841

(51) Int. Cl. B04B 11/00; B04B 11/08

(52) U.S. Cl. 494/29; 494/58

(57) ABSTRACT

Disclosed is a wet classification device in the form of a centrifuge provided with a stationary outer housing, a centrifugal drum arranged in the outer housing, a device for cleaning sediment deposited on the wall of the centrifugal drum, and inlets and outlets. The cleaning device comprises a shaft which extends into the centrifugal drum and has cutting devices arranged on the periphery thereof, in addition to a device for introducing a dispersing fluid in the centrifugal drum. The cutting devices are configured and arranged in such a way that turbulence can be created in the infed dispersing fluid, thereby resulting in a wash-out effect with respect to the sediment cake and facilitating the removal thereof.

The present invention is directed to a wet classification device in the form of a centrifuge provided with a stationary outer housing, a centrifugal drum arranged in the outer housing, a cleanig device for the sediment deposited on the wall of the centrifugal drum, and inlets and outlets.

Such a wet classification device is known. It is used for the separation of the coarse portion of powders, as titanium dioxide, for example. So, today more and more ultrafine materials having a particle size between 0,1-5 μm are used. Such particles sizes can be obtained by fine grinding of crude substances which, however, implies relatively high operating costs since the energy consumption is very high, cooling systems are required, a relatively high environmental contamination is caused and a large portion of undersized particles is generated etc. Such problems do not exist with wet classification centrifuges. Here, the solid (powder) is mixed with a liquid (normally water) in a pre-mixing tank in order to obtain a suspension. If necessary, the suspension is diluted in a following dilution tank and then introduced into the wet classification device which is formed as centrifuge. Within the rotating centrifugal drum the heavier and coarser particles are fed radially outwardly against the drum wall in a faster manner than the lighter and finer particles of the suspension, wherein they are deposited as sediment. The sediment is removed from the drum wall in cleaning phases of the wet classification device wherein for this, depending on the respective embodiment, cleaning liquids, mechanical cleaning means, as knives etc., are used. Finally, the sediment which is redispersed in the cleaning liquid is discharged from the centrifugal drum and is fed to a separately arranged ball mill, for instance, in which the coarse portion of the redispersed suspension is ground. Then, the process suspension can be introduced into the system again, for instance fed to the pre-mixing tank.

During the classification process the classified suspension is continuously withdrawn from the wet classification device and is made available for further usage.

When centrifuging ultrafine materials, in a plurality of application cases high centrifuging factors are required for a high separation effect in addition to an optimum rotor design. On account of these high centrifuging factors a very stable and very hard sediment cake is generated with a corresponding centrifuging time. Furthermore, in a plurality of applications hard substances having a hardness according to Mohs between 3 to 10 have to be centrifuged suspended in liquid. Normally, the devices known for the deletion of centrifuges fail in this connection, i.e. they cannot peel out or strip the sediment cake. This was confirmed in the past by worn knives, broken peeling devices as well as bent or broken knife shafts. Accordingly, on account of the high cutting forces also a braking of the main drive motor up to standstill occurs.

It is the object of the invention to provide a wet classification device of the above-cited kind with which the sediment cake can be peeled out or carried out in an especially problem-free manner.

According to the invention this object is obtained with a wet classification device of the cited kind by the following features:

The cleaning device includes a shaft pivotable or linearly movable in the centrifugal drum and having arranged at its periphery at least two slat-like cutting devices, and a device for the introduction of a dispersing liquid into the centrifugal chamber, and

the two cutting devices are inclined towards one another, form between them a space expanding in the moving direction of the shaft, and have a gap between them at their adjacent ends.

The above-cited problems are avoided with the inventive solution. Herewith it is possible to peel out or carry out the sediment cake without any problems and without causing damages at the cutting devices and the shafts carrying the same. In other words, the wear at the cutting devices and the shafts carrying the same is reduced, and smaller forces than with the prior art are generated so that fractures, deflections etc. of the cutting devices and the shafts are largely avoided. Even the problems generated with the prior art by the high cutting forces with regard to a negative influence (braking) of the main drive motor are avoided.

As mentioned above, this is obtained by a special design of the cleaning device of the wet classification device. With the cleaning device a combination of mechanical features together with the supply of a dispersing liquid is used. By the design of the mechanical features, i.e. the special arrangement and design of the cutting devices, a swirling of the supplied dispersing liquid is obtained which has a positive effect on the peeling and discharging of the sediment cake.

Especially, the cutting devices inclined towards one another and forming a space narrowing opposite to the moving direction of the shaft, which space terminates in a gap, have the effect that no linear flow conditions of the dispersing liquid are caused but turbulences are generated by the pushing back of the liquid towards the sediment occuring again and again, which turbulences cause an intensive swirling of the dispersing liquid resulting in an intensive wash-out effect on the surface of the sediment. By this, the cake can be removed in an easier and better manner by the cutting devices entering into the same, i.e. lower forces for the removal are necessary than with the prior art. The above-cited hydrodynamic effects are obtained by the narrowing of two adjacent cutting devices which results in the above-mentioned gap which has to be present in order to enable an although slight passing of the dispersing liquid.

Preferably, the dispersing liquid is added during the cutting in and back movement phases of the cleanig device.

The liquid in the centrifugal drum still present from the classification process is normally not sufficient in order to obtain the above-mentioned hydrodynamic effect (swirling in the region of the surface of the sediment cake).

It is guaranteed by the narrowing or expanding space that the additional dispersing liquid (diluting liquid) supplied during the cleaning process is fed to the largest drum diameter and thus also to the largest sediment mass. By this, the already mentioned intensive swirling results which brings along a certain wash-out effect of the cake, too. Accordingly, no concrete mechanical contact between the sediment cake and the tips of the cutting devices takes place. The sediment cake is rather liquified and carried out in a manner according to which the material is protected.

As regards the infeed of the dispersing liquid into the centrifugal drum, preferably the means for the introduction of the dispersing liquid opens in the head portion of the cutting devices in the centrifugal chamber. By this, the dispersing liquid is directly fed into the proximity of the surface of the sediment cake so that the desired swirling effect can be obtained very well. According to this solution the supplied dispersing liquid has not to be introduced first into the liquid column (classification liquid) present in the centrifugal drum but the introduction of the dispersing liquid is carried out directly within the liquid column which results in a number of advantages.

Investigations have shown that the slat-like cutting devices should be preferably arranged with an angle of 15-45° with respect to a plane perpendicularly intersecting the shaft axis in order to obtain the best results with regard to a peeling without problems.

Appropriately, the gap between the adjacent ends of the cutting devices is adjustable in response to the solids content and the viscosity of the suspension or further parameters. In this manner optimum conditions can be achieved for the respective application case. Of course, the size of the expanding or narrowing space (the spacing between the inclined cutting devices) is also adjusted by the above-mentioned gap adjustment. Also the cutting devices can be adjusted in such a manner that their angle of inclination is varied.

According to an especially preferred embodiment of the invention the gap expands additionally in the direction from the shaft towards the head of the cutting devices. Accordingly, a preferably double conical design results in this manner which additionlly favours the above-cited effects. By this, double turbulences are generated which further promote the removal. Accordingly, with this embodiment the space between the two cutting devices is additionally narrowed towards the smallest radius.

According to another embodiment of the invention the cutting devices or their heads have structured surfaces. These surfaces can be formed by the arrangement of grooves, ridges etc., for example. All the surfaces of the cutting devices or only a part of these surfaces can be structured. By this, an additional swirl generation in the supplied dispersing liquid is achieved.

The cutting devices can be removably disposed at the shaft and can be thus replaced depending on the respective case of application.

Preferably, the means for the introduction of the dispersing liquid has a channel extending through the shaft and from which channels extending through the cutting devices are branched off. Accordingly, the dispersing liquid can be fed up to the tips of the cutting devices and can flow out into the centrifugal chamber at a position adjacent to the sediment case.

The shaft can carry out a linear movement or a pivotal movement in order to move into the sediment cake. When a pivotal movement is carried out the shaft preferably moves about 80-120° in order to enter into the sediment. Accordingly, in this case the shaft carries out a step movement (forward and backward) through the desired angular range wherein this movement can be preferably adjusted in response to the respective product.

Practically, the means for the introduction of the dispersing liquid introduces the same during the cutting-in and back movement phases of the shaft.

As regards the design of the slat-like cutting devices, the invention does not have any restrictions. Known slat-like cutting devices (knives) can be used. Preferably, the slat-like cutting devices consist of flat steel profiles covered with high-strength material.

With the embodiment according to which the dispersing liquid is fed through channels extending through the cutting devices these channels preferably open at the front sides of the cutting devices so that the dispersing liquid flows out into the drum chamber from the front sides of the cutting devices.

The introduced dispersing liquid can be pressurized in order to further support the above-cited wash-out effect. In addition to a pure dispersing function it can also have further functions, for instance washing functions, adjustment functions for the concentration of solids etc.

The invention has especially good results if the centrifugal drum has chambers separated by separation walls. Preferably, the separation walls extend horizontally and form rings which are in connection with the outer wall of the drum. The arrangement of such separation walls is known on principle.

The present invention is especially used with wet classification devices having a slimness ratio of the centrifugal drum of L/D >1,2 wherein L is the length or height of the classification surface available in the centrifugal drum and D is the inner diameter of the centrifugal drum. Such a wet classification device is described in DE 199 25 082 A1. The disclosure of this publication is introduced into the present disclosure by reference.

Furthermore, the invention is suited especially well with a wet classification device which is provided with an integrated grinding device. For instance, such a wet classification device is described in DE 199 14 089 A1. The disclosure of this publication is introduced into the present disclosure by reference either.

Finally, the invention is especially well suited for a wet classification device which is simultaneously formed as dispersing device. For instance, such a device is described in DE 199 14 086 A1. The disclosure of this publication is introduced into the present disclosure by reference either.

Subsequently, the invention is described in detail by means of an example in connection with the drawing. Of the drawing

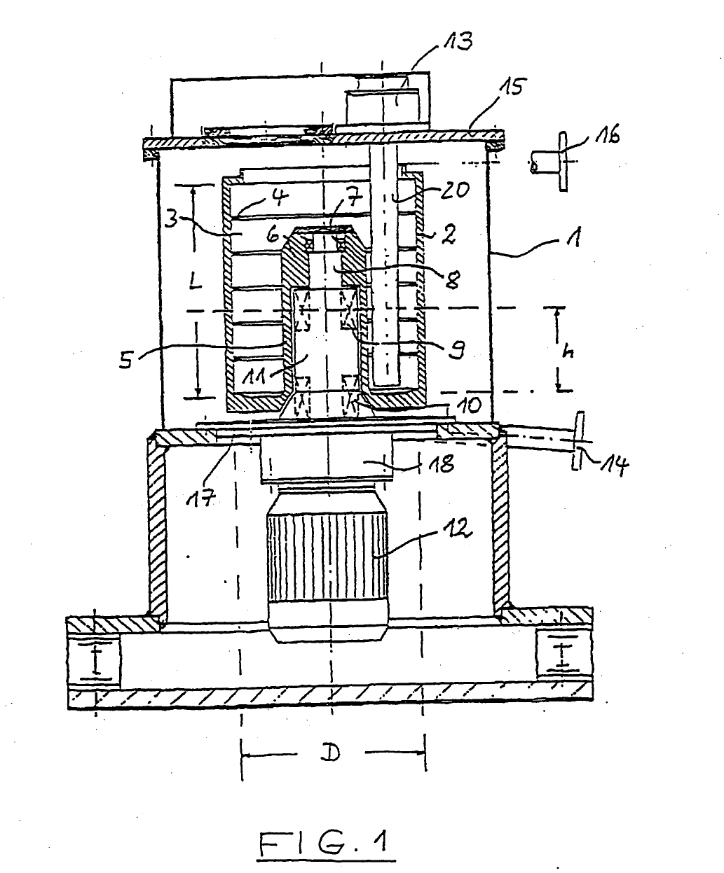

FIG. 1 shows a longitudinal section through a wet classification device wherein the cutting devices provided at the shaft are not represented;

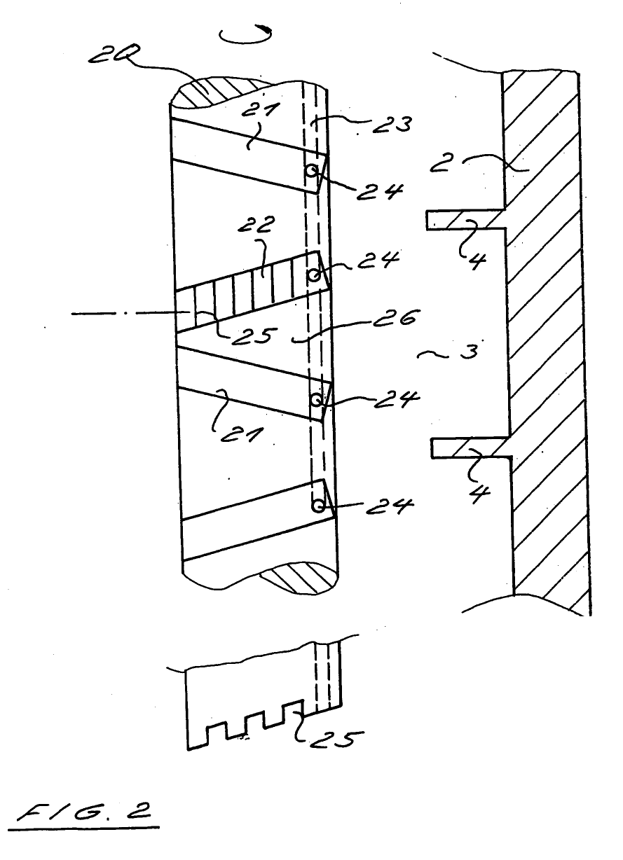

FIG. 2 shows an enlarged part-view of the shaft with cutting devices arranged thereon;

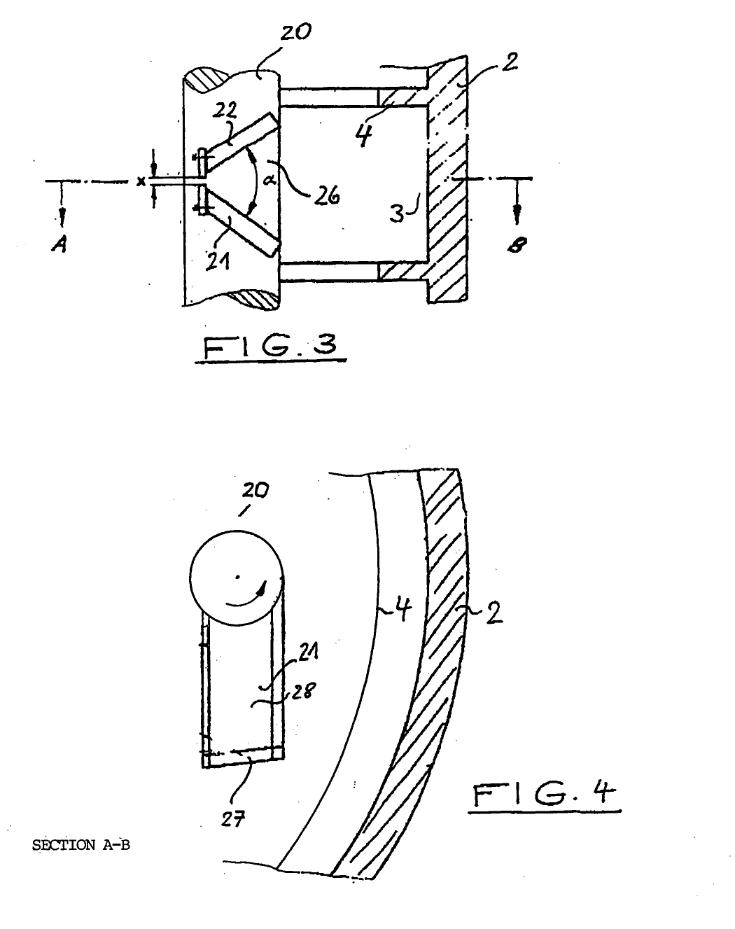

FIG. 3 shows a section from FIG. 2 with cutting devices shown in detail; and

FIG. 4 shows a sectional view along line A-B in FIG. 3.

The wet classification device in the form of a centrifuge shown in FIG. 1 has a stationary housing 1 with a lid 15 arranged thereupon. The stationary housing 1 is supported on a support framework through suitable vibration damping means. A centrifugal drum with vertical axis is arranged within the stationary housing 1 and is rotated by a vertical shaft 8. The vertical shaft 8 extends into the centrifugal drum 2 from below. It is surrounded by a support housing 11 containing an upper main bearing 9 and a lower second bearing 10 for the support of the shaft B. The support housing 11 is fastened to a plate 17 which again is fastened to the stationary housing 1. The shaft 8 extends through the support housing 11 and the plate 17 downwardly over a suitable clutch means 18 up to an electric motor 12 forming a direct drive. The speed of the shaft 8 is controllable.

The centrifugal drum 2 has an appropriate inlet (not shown) for the suspension which has to be classified which extends, for instance in the form of a tube, through the centrifugal drum which is open above into the same up to its lower end portion and has there an outflow opening. The classified suspension is withdrawn from the upper end of the centrifugal drum 2 through a discharge tube 16. A discharge tube 14 at the lower end of the centrifugal drum serves for withdrawing the sediment.

As one can further take from FIG. 1, the centrifugal drum is thus formed like a circular ring in its lower portion and formed circularly in its upper portion. Horizontal separation walls 4 divide the interior of the centrifugal drum into six classifying chambers 3 disposed one above the other and having radial end portions in which the sediment is deposited. The same is removed from there by a cleaning device which is schematically shown at 13.

The centrifugal drum 2 described here is formed as slim as possible, and the main bearing 9 of the shaft is arranged as centrally as possible, i.e. in the range of the center of gravity of the centrifugal drum. One recognizes that according to this the main bearing 9 is arranged so deep in the centrifugal drum that the vertical center of the main bearing 9 of the shaft 8 is arranged at a height h, measured from the inner lower end of the centrifugal drum, which corresponds to approximately 40% of the length or height L of the classifying surface available in the centrifugal drum 2. Furthermore, the slimness ratio L/D of the centrifugal drum, i.e. the ratio between the length or eight of the classifying surface available in the centrifugal drum and the inner diameter of the centrifugal drum, has a value of approximately 1,24. Of course, the above-cited values are only exemplary. According to this embodiment six classifying chambers 3 disposed one above the other result in the centrifugal drum 2.

As mentioned above, an upper main bearing 9 and a lower second bearing 10 for the shaft 8 are disposed within the support housing 11. In this manner a stable support results. The shaft 8 extends above out of the support housing 11 and terminates in a portion with reduced diameter. The central hub 6 of the centrifugal drum which is formed in the axial extension of the cylindrical inner wall 5 of the centrifugal drum is fixed at this portion. The fixation is realized through frictional contact (at 7). At the upper end the hub 6 is closed by a lid.

The operation of such a wet classification device is known and must no more discussed in detail at this place. It is essential that a large distance between inlet and outlet and thus a reduction of the danger of short circuit flows results by the selected high slimness ratio so that ultimately a better separation results. Furthermore, a high centrifugal factor (it can be operated with high speeds) and a large classifying surface are achieved by a plurality of chambers disposed one above the other.

Of course, on account of these circumstances especially high standards with respect to the operability of the cleaning device 13 have to be set since a correspondingly stable and very hard sediment cake is generated. These standards are fulfilled with the cleaning device described in the following.

The cleaning device 13 has a shaft 20 projecting into the centrifugal drum from above and carrying out a step movement (pivotal movement about an angle of approximately 80-120°) into the sediment cake formed at the drum wall and back into its original position. A dispersing liquid is introduced into the centrifugal drum not only during the cutting-in phase but also during the back movement phase of the shaft 20. Details are described later.

FIG. 2 shows an enlarged representation of a part of the shaft 20 of the cleaning device 13. This shaft is driven by means of a suitable step motor. A plurality of slat-like cutting devices 21, 22 are disposed at the periphery of the shaft one above the other, wherein two adjacent cutting devices 21, 22 are inclined towards one another and form between them a space 26 expanding in the direction of movement of the shaft 20 and have a gap X between them at their adjacent ends. The slat-like cutting devices 21, 22 (knives) are structured over their complete surfaces, i.e. provided with grooves, as schematically shown at 25 at a cutting device 22.

FIGS. 3 and 4 show the exact design of the cutting devices 21, 22. One recognizes that the cutting devices are inclined in such a manner that they are disposed with an angle (α/2) of 15-45° to a plane perpendicularly intersecting the shaft axis. In this embodiment the main plane of the cutting devices 21, 22 extends perpendicularly to the axis of the shaft 20, however, can also extend obliquely with respect to the same so that the gap X and the space 26 expand in radial direction towards a larger diameter either. The horizontal sectional view of FIG. 4 shows the lower cutting device 21 of FIG. 3 with its cutting head 27 and cutting beam 28. The cutting device consists of a flat profile of steel which is armoured.

FIG. 2 shows that a supply channel 23 for the dispersing liquid (cleaning liquid) is disposed within the shaft 20 and extends parallel with respect to the shaft axis. Two channels 24 extend from channel 23 through the respective slat-like cutting devices 21, 22 and open at the front surfaces (heads) of the cutting devices.

The gap X formed between the adjacent cutting devices and thus the expanding space 26 emanating from the same is adjustable.

The cleaning device operates in such a manner that the step motor (not shown) moves the shaft 20 anticlockwisely for about 80-120° into the sediment cake formed within the chambers 3. During this phase of movement dispersing liquid is supplied through the channels 23 and 24 and discharged into the drum chamber at the tips (heads) of the cutting devices. The outflowing dispersing liquid is again and again pushed towards the sediment cake by the inclined arrangement of the cutting devices and is swirled. By this, a corresponding wash-out process on the surface of the sediment cake is achieved so that it is no more necessary that the cutting devices directly contact the sediment cake. The sediment cake is rather liquified and thus peeled by the cutting devices in a material conserving manner. During the backward movement of the shaft dispersing liquid is supplied either so that a good and complete removal of the sediment cake can be achieved.

1. A wet classification device in the form of a centrifuge comprising a stationary outer housing (1), a centrifugal drum (2) arranged in the outer housing (1), a cleaning device (13) for the sediment deposited on the wall of the centrifugal drum, and inlets and outlets (14, 16), wherein
the cleaning device (13) includes a shaft (20) pivotably or linearly movable in the centrifugal drum (2) and having arranged at its periphery at least two slat-like cutting devices (21, 22), and a device for the introduction of a dispersing liquid into the centrifugal chamber (2), and
the two cutting devices (21, 22) are inclined towards one another, form between them a space (26) expanding in the moving direction of the shaft, and have a gap (X) between them at their adjacent ends.

2. The wet classification device according to claim 1, characterized in that the device for the introduction of dispersing liquid opens in the head range of the cutting devices (21, 22) into the drum chamber.

3. The wet classification device according to claim 1, characterized in that the slat-like cutting devices (21, 22) are arranged with an angle of 15-45° with respect to a plane perpendicularly intersecting the shaft axis.

4. The wet classification device according to claim 1, characterized in that the gap (X) is adjustable between the adjacent ends of the cutting devices (21, 22).

5. The wet classification device according to claim 1, characterized in that the gap (X) additionally expands in the direction from the shaft (20) towards the head (27) of the cutting devices (21, 22).

6. The wet classification device according to one claim 1, characterized in that the cutting devices (21, 22) or their heads (27) have structured surfaces (25).

7. The wet classification device according to claim 1, characterized in that the cutting devices (21, 22) are removably disposed at the shaft (20).

8. The wet classification device according to claim 1, characterized in that the device for the introduction of dispersing liquid includes a channel (23) extending through the shaft (20) and from which channels (24,) extending through the cutting devices (21, 22) are branched off.

9. The wet classification device according to claim 1, characterized in that the shaft (20) carries out a pivotal movement for 80-120° into the sediment.

10. The wet classification device according to claim 1, characterized in that the device for the introduction of dispersing liquid introduces the same during the cutting-in and back movement phases of the shaft (20).

11. The wet classification device according to claim 1, characterized in that the slat-like cutting devices (21, 22) consist of flat steel profiles covered with material of high strength.

12. The wet classification device according to claim 2, characterized in that the device for the introduction of dispersing liquid opens from the front sides of the cutting devices (21, 22) into the drum chamber.

13. The wet classification device according to claim 1, characterized in that the introduced dispersing liquid is pressurized.

14. The wet classification device according to claim 1, characterized in that the dispersing liquid has further functions, for instance washing functions, solid concentration adjustment functions etc.

15. The wet classification device according to claim 1, characterized in that the centrifugal drum (2) has chambers (3) separated by partitions (4).

16. The wet classification device according to claim 1, characterized in that the slimness ratio of the centrifugal drum (2) is L/D 7 1,2 wherein L means the length or height of the classifying surface available in the centrifugal drum (2) and D means the inner diameter of the centrifugal drum (2).

17. The wet classification device according to claim 1, characterized in that it is provided with an integrated grinding device.

18. The wet classification device according to claim 1, characterized in that it is simultaneously formed as dispersing device.
